(19) United States
(12) Patent Application Publication
(10) Pub. No.: US 2021/0306592 A1
(43) Pub. Date: Sep. 30, 2021

(54) IMAGE OBTAINING APPARATUS

(71) Applicant: LG ELECTRONICS INC., Seoul (KR)

(72) Inventors: Younghwan KWON, Seoul (KR); Gunshik SHIN, Seoul (KR); Jinsool LEE, Seoul (KR); Jeongho WOO, Seoul (KR); Sungbum JOO, Seoul (KR)

(73) Assignee: LG ELECTRONICS INC., Seoul (KR)

(21) Appl. No.: 17/257,489

(22) PCT Filed: Jul. 3, 2018
(86) PCT No.: PCT/KR2018/007518

§ 371 Date: Dec. 31, 2020

(51) Int. Cl. H04N 5/92; H04N 21/2343; H04N 19/114

(52) U.S. Cl. CPC H04N 5/92; H04N 19/114; H04N 21/234381; H04N 21/234345

(57) ABSTRACT

In order to address problems such as an increase in costs incurred when obtaining a slow motion and a time limit for video recording, an image processing apparatus is provided, the image processing apparatus comprising: an image sensor for obtaining a plurality of frames of an image which is to be recorded; an image signal processing unit for receiving the obtained plurality of frames from the image sensor and post-processing the received plurality of frames; an encoder for receiving, from the image signal processor, and encoding a first group of frames which are a part of the post-processed plurality of frames; and a buffer storage unit for receiving, from the image signal processor, and storing a second group of frames which are another part of the post-processed plurality of frames, wherein the encoder receives the second group of frames from the buffer storage unit and performs encoding so as to generate an image including the first group of frames and the second group of frames.

### TECHNICAL FIELD

The present disclosure relates to an image processing device capable of slow motion shooting and encoding.

### BACKGROUND ART

An image processing device that shoots an image may support a slow motion playback function. For the slow motion playback, it is necessary to have a frame obtaining speed higher than that in a case of shooting a general video. This is to slowly play frames obtained quickly in a slow motion section with a sufficient number of frames.

A concept of speed of obtaining, transmitting, processing, or encoding such a plurality of frames may be described on the basis of a frame per second (fps).

Several conditions are required for such slow motion shooting and encoding. First, an image sensor must be able to obtain a video at a target fps. Second, it must be able to transmit the obtained frames at a sufficient speed to an image signal processing unit. Thirdly, the image signal processing unit that received the frames must be able to perform post-processing (image signal processing) the frames at a sufficient speed. Further, fourthly, the post-processed frames must be able to perform the encoding at a sufficient speed in an encoder.

However, in the past, obtaining a high fps frame was meaningless because of a limitation of a transmission bandwidth (an MIPI bandwidth) of a camera module including the image sensor and an application processor including the image signal processing unit.

Conventionally, in order to solve such problem, a stacked memory scheme in which a buffer storage is added to the camera module was used. Some of the frames obtained by the image sensor was stored in the buffer storage of the camera module, then the remaining frames were transmitted to the image signal processing unit and were subjected to the post-processing, and then some frames described above were transmitted to the image signal processing unit. However, the stacked memory scheme has a disadvantage of causing an increase in a cost of the camera module, and there is a limit to a video recording time.

As another solution, when a subject of two images is moved, there is a method of determining the movement in pixel units to determine a position between frames of an object, and configuring it as a separate frame, through an image interpolation scheme. However, in this case, the configured frame corresponds to a virtual frame, which is not able to be viewed as a real frame. Therefore, problems such as image deterioration resulted from such limitation occur.

### DISCLOSURE

### Technical Purpose

The present disclosure aims to improve a problem such as an increase in a cost incurred in obtaining a slow motion, a time limit for video recording, or the like, which is described above.

### Technical Solutions

According to one aspect of the present disclosure to achieve the above or other purposes, provided is an image processing device including an image sensor for obtaining a plurality of frames of a video to be recorded, an image signal processing unit that receives the obtained plurality of frames from the image sensor and post-processes the received plurality of frames, an encoder that receives a first frame group from the image signal processing unit and encodes the first frame group, wherein the first frame group corresponds to some of the post-processed plurality of frames, and buffer storage for receiving a second frame group from the image signal processing unit and storing the second frame group therein, wherein the second frame group corresponds to some of the remaining post-processed frames, wherein the encoder receives the second frame group from the buffer storage and encodes the second frame group to create a video containing the first frame group and the second frame group.

In addition, according to another aspect of the present disclosure, provided is the image processing device, wherein the first frame group and the second frame group have a first frame shooting time interval or a second frame shooting time interval, wherein the first frame shooting time interval and the second frame shooting time interval are different from each other.

In addition, according to another aspect of the present disclosure, provided is the image processing device, wherein the first frame group has the first frame shooting time interval and the second frame group has the second frame shooting time interval.

In addition, according to another aspect of the present disclosure, provided is the image processing device, wherein the first frame shooting time interval is 30 fps and the second frame shooting time interval is 480 fps.

In addition, according to another aspect of the present disclosure, provided is the image processing device, the encoder creates the video by performing the encoding of the second frame group in an order of shooting after completing the encoding of the first frame group in the order of shooting.

In addition, according to another aspect of the present disclosure, provided is the image processing device further including an application processor that allocates a header for determining a playback order based on the first frame group and the second frame group to the created video.

In addition, according to another aspect of the present disclosure, provided is the image processing device, wherein a frame obtaining speed for the second frame group of the image sensor is 480 fps, wherein a frame post-processing speed for the second frame group of the image signal processing unit is 480 fps.

In addition, according to another aspect of the present disclosure, provided is the image processing device, wherein the image sensor obtains the frames of a full high definition (FHD) resolution.

In addition, according to another aspect of the present disclosure, provided is the image processing device, wherein the image signal processing unit, the buffer storage, and the encoder are mounted on an application processor.

In addition, according to another aspect of the present disclosure, provided is an image processing device including an image sensor for obtaining a plurality of frames of a video to be recorded, an image signal processing unit that receives the obtained plurality of frames from the image sensor and post-processes the received plurality of frames, buffer storage for receiving the post-processed plurality of frames from the image signal processing unit and storing the received post-processed plurality of frames therein, and an encoder that receives the stored plurality of frames from the buffer storage and encodes the received plurality of frames.

In addition, according to another aspect of the present disclosure, provided is the image processing device, wherein an encoding order of the encoder is the same as a frame obtaining order of the image sensor.

In addition, according to another aspect of the present disclosure, provided is an image processing device including an image sensor for obtaining a plurality of frames of a video to be recorded, buffer storage for receiving a third frame group and storing the third frame group therein, wherein the third frame group corresponds to some of the obtained plurality of frames, an image signal processing unit that receives and post-processes a fourth frame group, wherein the fourth frame group corresponds to some of the remaining obtained frames, and receives and post-processes the third frame group after the post-processing of the fourth frame group is completed, and an encoder that receives and encodes the post-processed fourth frame group and third frame group, wherein the image signal processing unit, the buffer storage, and the encoder are mounted on an application processor.

In addition, according to another aspect of the present disclosure, provided is an image processing device including an image sensor for obtaining a plurality of frames of a video to be recorded, an image signal processing unit that receives the obtained plurality of frames from the image sensor and post-process the received plurality of frames, a first encoder that receives a first frame group from the image signal processing unit and encodes the first frame group, wherein the first frame group corresponds to some of the post-processed plurality of frames, buffer storage for receiving a second frame group from the image signal processing unit and storing the second frame group therein, wherein the second frame group corresponds to some of the remaining post-processed frames, and a second encoder that receives the second frame group from the buffer storage and encodes the second frame group.

In addition, according to another aspect of the present disclosure, provided is the image processing device further including an application processor that synthesizes a first video encoded by the first encoder and a second video encoded by the second encoder in an order of a shooting time.

### Advantageous Effects

Effects of the image processing device according to the present disclosure are as follows.

According to at least one of the embodiments of the present disclosure, there is an advantage in that a slow motion video may be created regardless of specifications of a camera module.

In addition, according to at least one of the embodiments of the present disclosure, there is an advantage of minimizing a manufacturing cost of the image processing device.

In addition, according to at least one of the embodiments of the present disclosure, there is an advantage in that a video containing a high fps slow motion may be created.

In addition, according to at least one of the embodiments of the present disclosure, there is an advantage that a processing speed of video creation may be increased.

Further scope of the applicability of the present disclosure will become apparent from a detailed description below. However, various changes and modifications within the spirit and scope of the present disclosure may be clearly understood by those skilled in the corresponding technical field, so that it is to be understood that the detailed description and specific embodiments such as preferred embodiments of the present disclosure are given by way of example only.

### DESCRIPTION OF DRAWINGS

(a) in FIG. 1 is a block diagram of an image processing device 100 in accordance with the present disclosure.

(b) and (c) in FIG. 1 are conceptual views of one example of an image processing device 100 in accordance with the present disclosure, viewed from different directions.

FIG. 2 is a block diagram of main components of an image processing device in accordance with the present disclosure.

FIG. 3 is a conceptual diagram of obtaining and playing of frames in accordance with the present disclosure.

FIG. 4 shows a form of a conventional image processing device.

FIG. 5 is a conceptual diagram of an embodiment of an image processing device in accordance with the present disclosure.

FIG. 6 is an embodiment having a flow of FIG. 5.

FIG. 7 is a conceptual diagram of another embodiment of an image processing device in accordance with the present disclosure.

FIG. 8 is a conceptual diagram of another embodiment of an image processing device in accordance with the present disclosure.

FIGS. 9 and 10 are conceptual diagrams of encoding and playback orders in accordance with the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Image processing devices presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of image processing devices. However, such teachings apply equally to other types of devices, such as those types noted above. In addition, these teachings may also be applied to stationary terminals such as digital TV, desktop computers, and the like.

Reference is now made to FIGS. 1A-1C, where FIG. 1A is a block diagram of an image processing device in accordance with the present disclosure, and FIGS. 1B and 1C are conceptual views of one example of the image processing device, viewed from different directions.

The image processing device 100 is shown having components such as a wireless communication unit 110, an input unit 120, a sensing unit 140, an output unit 150, an interface unit 160, a memory 170, a controller 180, and a power supply unit 190 Referring now to FIG. 1A, the image processing device 100 is shown having wireless communication unit 110 configured with several commonly implemented components. It is understood that implementing all of the illustrated components is not a requirement, and that greater or fewer components may alternatively be implemented.

More specifically, the wireless communication unit 110 typically includes one or more modules which permit communications such as wireless communications between the image processing device 100 and a wireless communication system, communications between the image processing device 100 and another image processing device, communications between the image processing device 100 and an external server. Further, the wireless communication unit 110 typically includes one or more modules which connect the image processing device 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The camera 121 viewed with the configuration of the input unit 120 includes at least one of a camera sensor (e.g., a CCD, a CMOS, and the like), an image sensor, and a laser sensor.

The camera 121 and the laser sensor are combined with each other to sense a touch of a sensing target for a 3D stereoscopic image. The image sensor may be stacked on a display device, which is configured to scan a motion of the sensing target close to a touch screen. More specifically, the image sensor mounts photo diodes and transistors (TRs) in a row/column and scans an object placed on the image sensor using an electrical signal that changes based on an amount of light applied to the photo diodes. That is, the image sensor calculates coordinates of the sensing target based on a change amount of the light. Thus, location information of the sensing target may be obtained.

The sensing unit 140 is typically implemented using one or more sensors configured to sense internal information of the image processing device, the surrounding environment of the image processing device, user information, and the like. For example, the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The image processing device 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the image processing device 100 and a user, as well as function as the user input unit 123 which provides an input interface between the image processing device 100 and the user.

The interface unit 160 serves as an interface with various types of external devices that can be coupled to the image processing device 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the image processing device 100 may perform assorted control functions associated with a connected external device, in response to the external device being connected to the interface unit 160.

The memory 170 is typically implemented to store data to support various functions or features of the image processing device 100. For instance, the memory 170 may be configured to store application programs executed in the image processing device 100, data or instructions for operations of the image processing device 100, and the like. Some of these application programs may be downloaded from an external server via wireless communication. Other application programs may be installed within the image processing device 100 at time of manufacturing or shipping, which is typically the case for basic functions of the image processing device 100 (for example, receiving a call, placing a call, receiving a message, sending a message, and the like). It is common for application programs to be stored in the memory 170, installed in the image processing device 100, and executed by the controller 180 to perform an operation (or function) for the image processing device 100.

The controller 180 typically functions to control overall operation of the image processing device 100, in addition to the operations associated with the application programs. The controller 180 may provide or process information or functions appropriate for a user by processing signals, data, information and the like, which are input or output, or activating application programs stored in the memory 170.

A physical shape of the controller 180 may be a chipset mounted on the image processing device 100, in particular, an application processor to be described later.

To drive the application programs stored in the memory 170, the controller 180 may be implemented to control a predetermined number of the components mentioned above in reference with FIG. 1A. Moreover, the controller 180 may be implemented to combinedly operate two or more of the components provided in the image processing device 100 to drive the application programs.

The power supply unit 190 can be configured to receive external power or provide internal power in order to supply appropriate power required for operating elements and components included in the image processing device 100. The power supply unit 190 may include a battery, and the battery may be configured to be embedded in the terminal body, or configured to be detachable from the terminal body.

Some or more of the components may be operated cooperatively to embody an operation, control or a control method of the image processing device in accordance with embodiments of the present disclosure. Also, the operation, control or control method of the image processing device may be realized on the image processing device by driving of one or more application problems stored in the memory 170.

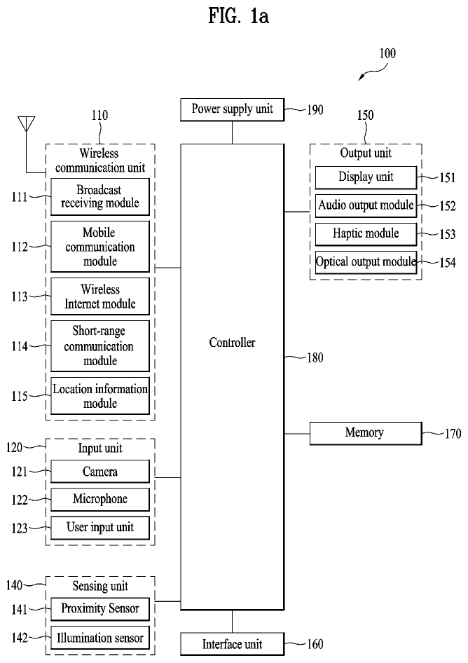

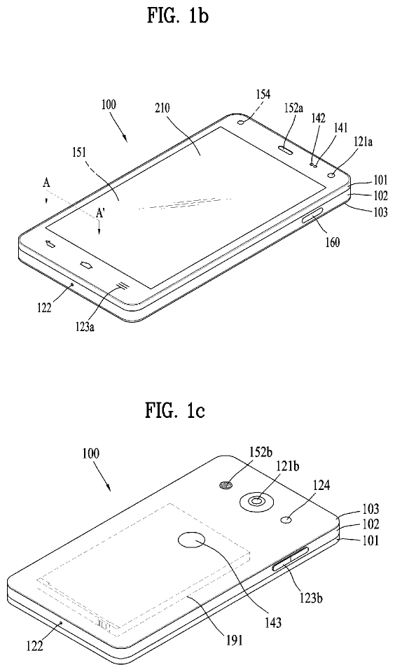

FIG. 2 is a block diagram of main components of an image processing device in accordance with the present disclosure. Further, FIG. 3 is a conceptual diagram of obtaining and playing of frames in accordance with the present disclosure.

Specifically, (a) in FIG. 3 is a conceptual diagram of obtaining of frames of a video including a slow motion, and (b) in FIG. 3 is a conceptual diagram of reproducing of the frames obtained by (a) in FIG. 3 as a slow motion video.

For convenience of description, reference is made to FIGS. 2 and 3 together. In addition, FIGS. 2 and 3 may be referred to in all embodiments to be described later.

The image processing device includes an image sensor 210, an image signal processing unit 310, and an encoder 320.

The image sensor 210 obtains frames of a video to be recorded. Because a plurality of frames are collected to form the video, the image sensor 210 obtains the plurality of frames.

Physically, an image of a shooting target is formed on the image sensor 210 to form an information signal. Because the present disclosure relates to creation and output of the video, the image and the frame will not be distinguished and be used interchangeably unless there is a specific limitation in a description below.

The image signal processing unit 310 receives the image obtained by the image sensor 210 and performs post-processing (image signal processing (ISP)). The image signal processing unit 310 converts an image of a Bayer format into a YUV format.

The encoder 320 creates the video by encoding the post-processed plurality of frames.

In particular, the present disclosure relates to creation of a video containing a slow motion video. The video may contain only the slow motion video, or may contain the slow motion video and a general video. The general video means a video with the same shooting speed and playback speed, and the slow motion video means a video with a playback speed slower than the shooting speed.

When creating the general video that does not contain the slow motion, it is sufficient that a frame obtaining speed of the image sensor 210, a transmission speed to the image signal processing unit 310, an encoding speed of the encoder 320, or a playback fps of the encoded video are the same. For example, in order to create a video of 30 fps, the image sensor 210 obtains frames at 30 fps, the obtained frames are transmitted from the image sensor 210 to the image signal processing unit 310 at 30 fps, and the encoder 320 receives the image signal-processed frames and encodes the frames at 30 fps.

In order to create the slow motion video, it is necessary to have a frame obtaining speed higher than that in a case of shooting the general video. For example, when the frame obtaining speed for the general video is 30 fps, the frame obtaining speed for the slow motion video requires obtaining many frames over the same time period, such as 240 fps, 480 fps, or 960 fps.

However, it is not possible to create the slow motion video simply by obtaining many frames over time, and the obtained frames must be transmitted, processed, and encoded without loss.

In order to encode the slow motion video, following conditions are required. First, the image sensor 210 must be able to obtain the image with a sufficient fps. Second, it must be able to transmit the obtained frames at a sufficient fps to the image signal processing unit 310. Thirdly, the image signal processing unit 310 that received the frames must be able to perform the post-processing (the image signal processing) the frames at a sufficient speed. Fourth, the encoder 320 must receive the frames at a target encoding fps.

In order to create the slow motion video, the frames obtained at high fps must be encoded at low fps. Because the above process is a series of processes that are processed in a bypass form, even when the obtaining speed, the transmission speed, and the like are sufficient in the image sensor 210, and the like are sufficient, when the encoding fps of the encoder 320 is smaller than those, omission of the transmitted frames occurs. Therefore, it is not possible to obtain enough frames to play the slow motion.

For example, even when the image sensor 210 obtains the image at 480 fps for creating the slow motion video and the image signal processing unit 310 post-processes the image at 480 fps, when the encoder 320 performs the encoding at 30 fps, the encoder 320 is not able to process the image properly when the image is transmitted at 480 fps, so that a loss of 450 fps occurs, and thus, the slow motion video may not be created. Therefore, there is a need for a device that supplies the frames at an appropriate time such that the encoder 320 is able to process the frames corresponding to the slow motion at a target fps.

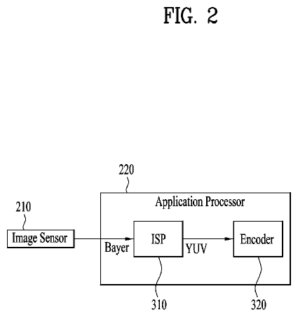

FIG. 4 shows a form of a conventional image processing device.

As a conventional technology for solving the above problem, there is a scheme of a stacked memory 410. The stacked memory scheme is a technology in which the image sensor 210 and the stacked memory 410 are arranged together in a camera module, and at least some of the frames obtained by the image sensor 210 is stored in the stacked memory 410 and then transmitted to the image signal processing unit 310.

However, the camera module in the stacked memory scheme is not only expensive, but also has a limitation of a transmission bandwidth (an MIPI bandwidth) of a transmission from the image sensor 210 to the image signal processing unit 310 and a storage limitation of the stacked memory 410. Therefore, when the stacked memory 410 is disposed in the camera module, there is a disadvantage in that a manufacturing cost may increase and a playback time of the slow motion video may be shortened.

The present disclosure proposes a method for creating the slow motion video by overcoming the above constraints and existing problems.

In order to improve the above problems, the image processing device may include buffer storage 330 outside the camera module.

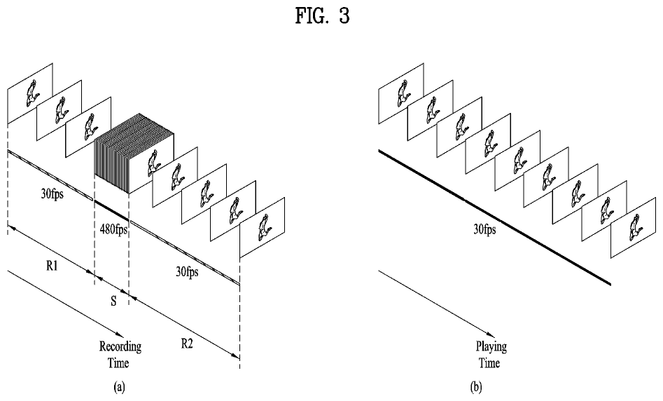

FIG. 5 is a conceptual diagram of an embodiment of an image processing device in accordance with the present disclosure.

The buffer storage may be disposed between the image signal processing unit 310 and the encoder 320. The fact that the buffer storage 330 is located between the image signal processing unit 310 and the encoder 320 means a location of a path in signal processing and does not mean a physical location. The buffer storage 330 may include a dynamic random access memory (DRAM). The DRAM is a type of a RAM, which is relatively slow, but has a large storage space. This has an advantage over a cache memory in that it requires a large capacity because of characteristics of the slow motion video, and the DRAM has a relatively large capacity.

The buffer storage 330 may be disposed on one chipset together with the image signal processing unit 310 and the encoder 320. The chipset may in particular be an application processor (AP) 220. The application processor 220 performs various functions of a graphics processing unit (GPU), a communication chip, a sensor, and the like as well as a role of a central processing unit (CPU) in the image obtaining device. That is, the application processor 220 may mean a system on chip (SOC).

However, the buffer storage 330 may be disposed in another region inside the image processing device as needed. The buffer storage 330 may be formed using a RAM in the image processing device that is conventionally used for another purpose. In this case, the increase in the manufacturing cost may be minimized in that there is no need to add a separate component to achieve the purpose of the present disclosure.

Because of the disposition of the buffer storage 330, some of the frames post-processed in the image signal processing unit 310 may be directly transmitted to the encoder 320, and others may be transmitted to the buffer storage 330 and stored. The set of frames directly transmitted to the encoder 320 is defined as a first frame group, and the set of frames transmitted to the buffer storage 330 is defined as a second frame group.

A set of the first frame group and the second frame group may be entire frames post-processed by the image signal processing unit 310, or may be a set in which some of the frames are missing. However, unless there are special reasons, the former is appropriate, and therefore, a description will be achieved based on the former case.

Assuming the general video containing the slow motion video, the corresponding video may include frames obtained at low fps for the general video and frames obtained at high fps for the slow motion video. Fps at which the former frames are obtained is defined as a first frame shooting time interval, and fps at which the latter frames are obtained is defined as a second frame shooting time interval. The first frame shooting time interval will be the same as the encoding fps of the encoder 320. For example, when the encoding fps of the encoder 320 is 30 fps, the first frame shooting time interval is 30 fps. The second frame shooting time interval may be 480 fps or 960 fps.

Because the first frame group and the second frame group are distinguished from each other based on the shooting time interval, paths thereof do not need to be different. Accordingly, frames shot with the first frame shooting time interval and frames shot with the second frame shooting time interval may be mixed and arranged in the first frame group and the second frame group.

However, for an efficiency of the frame processing, it is preferable that the first frame group is a set of frames shot with the first frame shooting time interval, and the second frame group is a set of frames shot with the second frame shooting time interval. That is, the frames shot for the general video may be directly transmitted from the image signal processing unit 310 to the encoder 320, and the frames shot for the slow motion video may be transmitted later to the encoder 320 through the buffer storage 330.

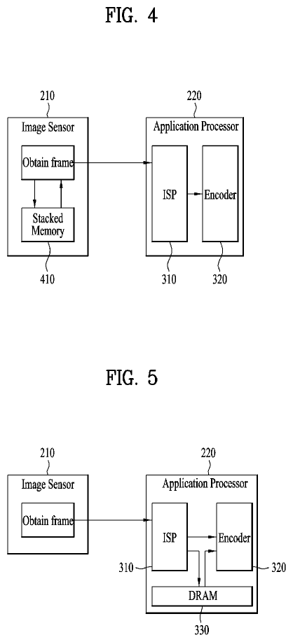

FIG. 6 is an embodiment having a flow of FIG. 5. (a) in FIG. 6 illustrates a flowchart of a general video frame, and (b) in FIG. 6 illustrates a flowchart of a slow motion video frame.

For example, assuming that a video is composed of a combination of 30 fps and 480 fps as shown in (a) in FIG. 3, as described above, the frames obtained at 30 fps may be classified into the first frame group, and the frames obtained at 480 fps may be classified into the second frame group.

In this case, based on the description related to FIG. 5, the first frame group is encoded based on the flow in (a) in FIG. 6, and the second frame group is encoded based on the flow in (b) in FIG. 6.

Based on (a) in FIG. 3, a circuit in (a) in FIG. 6 will operate when recording an initial region R1, then, a circuit in (b) in FIG. 6 will operate when recording a region S, and then, the circuit in (a) in FIG. 6 will operate again when recording a region R2. However, this is for the frames reaching the buffer storage 330, and it is appropriate that an order in which the encoder 320 receives and encodes the frames is an order of the frames of the R1, R2, and S. That is, the encoder 320 may complete encoding of the first frame group in the shooting order (R1->R2), and then perform encoding of the second frame group to create the video.

However, in order to satisfy a condition of (b) in FIG. 6, it is assumed that the transmission bandwidth (the MIPI bandwidth) supports 480 fps. This may depend on specifications of the application processor 220.

Frame transmission fps and an image quality of the frame may be determined based on a maximum transmission bandwidth. That is, in terms of the transmission bandwidth, the frame transmission fps and the image quality of the frame are in a trade-off relationship.

As in the present disclosure, when the frame is transmitted at 480 fps, there is an advantage in that up to an image quality of a full high definition (FHD) may be implemented.

Based on the flow described above, the capacity of the buffer storage 330 may determine a maximum time of the S in (a) in FIG. 3. That is, as the capacity of the buffer storage 330 increases, the capacity of the slow motion video may be increased. However, it is preferable to specify the maximum time of the slow motion video in consideration of not only the capacity of the buffer storage 330 but also an overall processing speed, heat generation, and the like of the application processor 220.

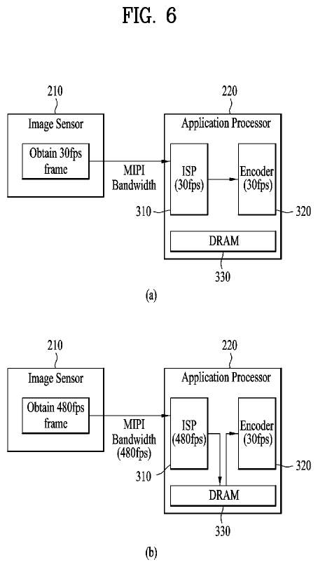

FIG. 7 is a conceptual diagram of another embodiment of an image processing device in accordance with the present disclosure.

Unlike the embodiments in FIGS. 5 and 6, the frames post-processed by the image signal processing unit 310 may be collectively transmitted to the encoder 320 through the buffer storage 330 without distinguishment. In this case, because the encoding order of the encoder 320 and the frame obtaining order of the image sensor 210 are the same, there is an advantage in that no separate processing is required for matching a playback order in the encoding step and the like.

Other features apply equally within the scope not contrary to those described in the preceding embodiments.

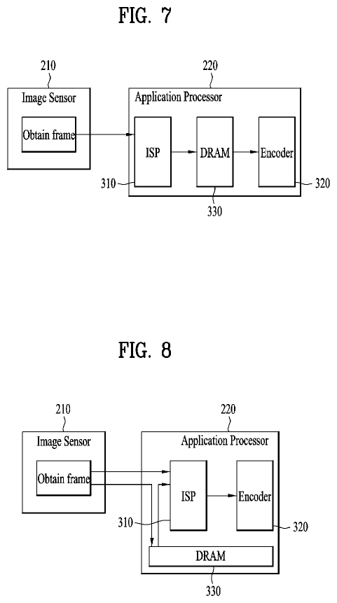

FIG. 8 is a conceptual diagram of another embodiment of an image processing device in accordance with the present disclosure.

Unlike the embodiments in FIGS. 5 to 7, the buffer storage 330 may be disposed between the image sensor 210 and the image signal processing unit 310.

However, unlike the embodiment in FIG. 4, which is the conventional form, the buffer storage 330 may be disposed at a point of the image processing device rather than the camera module. In particular, as described above, the buffer storage 330 may be implemented on the application processor 220. However, the buffer storage 330 may be disposed in another region inside the image processing device as needed.

In this case, the image before the post-processing in the Bayer format is stored in the buffer storage 330. This is distinguished from the fact that the frame in the YUV format, which is the post-processed image in the embodiments in FIGS. 5 to 7, is stored in the buffer storage 330.

As in the embodiment in FIG. 5 or 7, some of the frames obtained by the image sensor 210 may be directly transmitted to the image signal processing unit 310, others may be transmitted to the buffer storage 330, or all the frames may be transmitted to the buffer storage 330.

The frames transmitted directly to the image signal processing unit 310 is defined as a third frame group, and the frames transmitted to the buffer storage 330 is defined as a fourth frame group. The third frame group corresponds to the above-described first frame group, and the fourth frame group corresponds to the above-described second frame group.

The present embodiment may be equally applied to the extent not contradictory to the features described in the preceding embodiments.

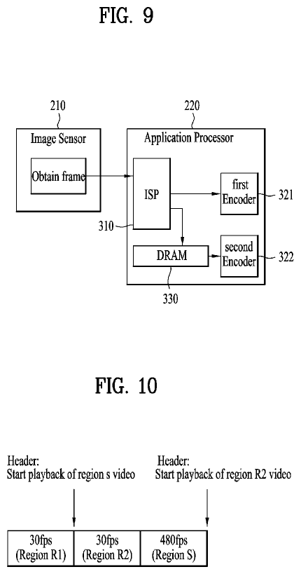

FIGS. 9 and 10 are conceptual diagrams of encoding and playback orders in accordance with the present disclosure.

When the first frame group and the second frame group are encoded separately from each other as shown in the embodiments in FIGS. 3 and 6, because the encoder 320 creates the video in the order of the frames of R1, R2, and S, there is a need for a method for playing the video in the order of shooting time.

Features to be described later are only such an embodiment, and cover all cases in which the encoding is not performed based on the shooting time or the encoding is performed separately, in addition to such situation.

FIG. 9 is a conceptual diagram of another embodiment of an image processing device in accordance with the present disclosure.

The present embodiment is described on the premise that the buffer storage 330 is disposed between the image signal processing unit 310 and the encoder 320 as shown in FIGS. 5 to 7, but is not limited thereto. The present embodiment may also be applied to the positional relationship of the buffer storage 330 as shown in FIG. 8.

The encoder 320 may include a plurality of encoders. That is, the encoder 320 may include a first encoder 321 for the general video encoding and a second encoder 322 for the slow motion video encoding. That is, the first encoder 321 may be connected to the image signal processing unit 310 without being connected to the buffer storage 330 to receive the first frame group and perform the encoding, and the second encoder 322 may be connected to the image signal processing unit 310 through the buffer storage 330 to receive the second frame group and perform the encoding.

A first video created by the first encoder 321 and a second video created by the second encoder 322 may be synthesized based on a shooting order or a creation order to create a final video.

FIG. 10 is a conceptual diagram of another embodiment of an image processing device in accordance with the present disclosure.

The encoder 320 is disposed as a single unit. The general video may be transmitted to the encoder 320 without passing through the buffer storage 330 and be encoded, and the slow motion video may be transmitted to the encoder 320 through the buffer storage 330 and be encoded. In this case, the encoding of the slow motion video will proceed after the encoding of the general video is completely done. Accordingly, the encoder 320 may create the video in an order of a time at which the encoding is performed.

However, it is also possible to allocate header data to a point, which is a boundary between the normal video and the slow motion video, and play the video in a chronological order by changing a playback position based on such header. The header may be allocated under control of the application processor 220.

[Mode]

Further preferred embodiments will be described in more detail with reference to additional drawing figures. It is understood by those skilled in the art that the present features can be embodied in several forms without departing from the characteristics thereof.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal. The above detailed description should not be construed as being limitative in all terms, but should be considered as being illustrative. The scope of the present invention should be determined by reasonable analysis of the accompanying claims, and all changes in the equivalent range of the present invention are included in the scope of the present invention.

### INDUSTRIAL APPLICABILITY

The features of the present disclosure may be partially or entirely applied to the image obtaining device in the present technical field.

1. An image processing device comprising:
an image sensor for obtaining a plurality of frames of a video to be recorded;
an image signal processor configured to receive the obtained plurality of frames from the image sensor and post-process the received plurality of frames;
an encoder configured to receive a first frame group from the image signal processor and encode the first frame group, wherein the first frame group corresponds to some of the post-processed plurality of frames; and
buffer storage for receiving a second frame group from the image signal processor and storing the second frame group therein, wherein the second frame group corresponds to some remaining frames of the post-processed plurality of frames,
wherein the encoder is further configured to receive the second frame group from the buffer storage and encode the second frame group to create a video containing the first frame group and the second frame group.

2. The image processing device of claim 1, wherein the first frame group and the second frame group have a first frame rate or a second frame rate, wherein the first frame rate and the second frame rate are different from each other.

3. The image processing device of claim 2, wherein the first frame group has the first frame rate, and wherein the second frame group has the second frame rate.

4. The image processing device of claim 3, wherein the first frame rate is 30 fps and the second frame rate is 480 fps.

5. The image processing device of claim 4, wherein the encoder is further configured to create the video by performing the encoding of the second frame group in an order of shooting after completing the encoding of the first frame group in the order of shooting.

6. The image processing device of claim 5, further comprising:
an application processor configured to allocate, to the created video, a header for determining a playback order based on the first frame group and the second frame group.

7. The image processing device of claim 4, wherein a frame obtaining speed of the image sensor for the second frame group is 480 fps,
wherein a frame post-processing speed of the image signal processor for the second frame group is 480 fps.

8. The image processing device of claim 7, wherein the image sensor obtains the plurality of frames of a full high definition (FHD) resolution.

9. The image processing device of claim 1, wherein the image signal processor, the buffer storage, and the encoder are mounted on an application processor.

10. An image processing device comprising:
an image sensor for obtaining a plurality of frames of a video to be recorded;
an image signal processor configured to receive the obtained plurality of frames from the image sensor and post-process the received plurality of frames;
buffer storage for receiving the post-processed plurality of frames from the image signal processor and storing the received post-processed plurality of frames therein; and
an encoder configured to receive the stored plurality of frames from the buffer storage and encode the received plurality of frames.

11. The image processing device of claim 10, wherein an encoding order of the encoder is same as a frame obtaining order of the image sensor.

12. An image processing device comprising:
an image sensor for obtaining a plurality of frames of a video to be recorded;
buffer storage for receiving a first frame group and storing the first frame group therein, wherein the first frame group corresponds to some of the obtained plurality of frames;
an image signal processor configured to:
receive and post-process a second frame group, wherein the second frame group corresponds to some remaining frames of the obtained plurality of frames; and
receive and post-process the first frame group after the post-processing of the second frame group is completed; and
an encoder configured to receive and encode the post-processed second frame group and the post-processed first frame group,
wherein the image signal processor, the buffer storage, and the encoder are mounted on an application processor.

13. An image processing device comprising:
an image sensor for obtaining a plurality of frames of a video to be recorded;
an image signal processor configured to receive the obtained plurality of frames from the image sensor and post-process the received plurality of frames;
a first encoder configured to receive a first frame group from the image signal processor and encode the first frame group, wherein the first frame group corresponds to some of the post-processed plurality of frames;
buffer storage for receiving a second frame group from the image signal processor and storing the second frame group therein, wherein the second frame group corresponds to some remaining frames of the post-processed plurality of frames; and
a second encoder configured to receive the second frame group from the buffer storage and encode the second frame group.

14. The image processing device of claim 13, further comprising:
an application processor configured to synthesize a first video encoded by the first encoder and a second video encoded by the second encoder in an order of a shooting time.
